(19) United States
(12) Patent Application Publication
(10) Pub. No.: US 2018/0026707 A1
(43) Pub. Date: Jan. 25, 2018

(54) SYSTEM AND METHOD FOR RE-BROADCASTING ADS-B DATA

(71) Applicant: Harry Sanders, Asheboro, NC (US)

(72) Inventor: Harry Sanders, Asheboro, NC (US)

(21) Appl. No.: 15/657,129

(22) Filed: Jul. 22, 2017

Related U.S. Application Data
(60) Provisional application No. 62/365,761, filed on Jul. 22, 2016.

(51) Int. Cl. H04B 7/185; G08G 5/00

(52) U.S. Cl. CPC H04B 7/18506; G08G 5/0013; G08G 5/0008

(57) ABSTRACT

An ADS-B to the surface system has a modified ADS-B UAT to the surface which receives traffic and weather information from a nearby FAA ADS-B Ground Based Transceiver. The UAT to the surface sends the information to a UAT computer which then packages and sends traffic and weather data over an appropriate network to one or more remote computers. The system also has a mini ADS-B Ground Based Transceiver which provides local traffic information to the remote computer which consolidates the information with the information from the UAT computer and then sends the consolidated information to the mini ADS-B Ground Based Transceiver which transmits the information to local aircraft. The remote computer also sends local only data to the FAA over an appropriate network for inclusion in the FAA Ground Based Transceiver information.

### FIELD OF THE INVENTION

The present invention relates to an enhancement for the Automated Dependent Surveillance-Broadcast (ADS-B) system which has been adopted by the United States and other countries to provide data information for management of aircraft traffic. More specifically, the present invention relates to a system and method for receiving and re-broadcasting ADS-B data to provide ADS-B data to aircraft in airspace having weak or no ADS-B coverage and providing the ADS-B data to the FAA for aircraft not currently received by FAA Ground Based Transceivers.

### BACKGROUND OF THE INVENTION

The FAA's Automatic Dependent Surveillance Broadcast (ADS-B) is an aircraft tracking technology that allows pilots and air traffic controllers to “see” aircraft traffic with much more precision than is possible with current radar thus providing safer and more efficient flight in our airspace. ADS-B is part of the FAA's NextGen Air Traffic Management system.

The FAA NextGen system tracks aircraft using the aircraft's “ADS-B Out” transmitted data which transmits packets providing the aircraft's position, altitude, speed and other data on either 978 MHz or 1090 MHz. The FAA's Ground Based Transceivers (GBTs) receive the ADS-B data from the ADS-B Out equipped aircraft, combine this data with radar data from FAA Radar sites, and then transmit the combined data to aircraft equipped with “ADS-B In”, Aircraft equipped with “ADS-B In”, either 978 MHz or 1090 MHz, can receive this ADS-B traffic data. The FAA GBTs also transmit weather data to ADS-B receivers that use the 978 MHz (UAT—Universal Access Transceiver) frequency and both traffic and graphical weather and text-based advisories can be viewed on devices which have been programmed to receive and display the data.

The ADS-B system provides a significant improvement in aviation safety by providing near real time aircraft traffic and weather to airborne aircraft within ADS-B coverage areas. However, most small airports and their surrounding airspace are outside ADS-B coverage from ground level to 1500 ft above ground level (AGL) and in some locations up to 3000 ft AGL. Thus, during the critical flight segments of taxi, takeoff, landing, and low altitude flight near small airports and remote areas, aircraft do not have access to ADS-B data.

The FAA ADS-B GBT's operate on a line of sight basis. Although the FAA has installed numerous GBT's around the country, many General Aviation (GA) airports as well as vast areas not close to the FAA GBT's do not have a direct line of sight to the GBT's due to distance and obstacles like trees, terrain, and buildings. Aircraft must have a line of sight to the GBT towers/facilities in order for the participating ADS-B aircraft to be received by the GBT or receive data from the GBT. Low flying aircraft and UAV's (Unmanned Aerial Vehicles, e.g. drones) often do not have a clear line of sight to a nearby FAA GBT, The FAA guarantees national ADS-B coverage above 1,500 ft AGL (3,000 ft AGL in many areas) thus leaving most of the nation's 5000+ General Aviation (GA) airports and remote areas without coverage to ground levels. Therefore, traffic cannot be tracked in some of the most critical stages of flight, low altitudes and takeoffs/landings. Aircraft Pilots and UAS Operators are essentially without ADS-B traffic or weather from the surface to traffic pattern altitude levels near the small uncontrolled airports and under the floor of many Class B, C, E, and within D and G Airspaces.

The present invention offers a significant improvement for the ADS-B system using a custom designed mGBT (mini Ground Based Transceiver) and a modified ADS-B UAT (Universal Access s Transceiver using 978 MHz) which can bring national ADS-B coverage down to the surface for most of the nation's small airports or under Class B, C, E, and within Class D, and G Airspaces and also for remote locations. The system of the present invention provides local low altitude ADS-B coverage at a reasonable cost to fill the gap in national ADS-B coverage where line of sight to a FAA GBT does not exist. An additional national value is that the ADS-B data received directly by the mGBT network can be provided to the FAA GBTs thus providing the FAA with low altitude traffic that is not available to their current ADS-B system. The current invention is intended to work equally well for all aircraft including UAV's. The current invention supports the 978 MHz and the 1090 MHz (International Standard ADS-B Frequency) capability to provide ADS-B to the surface both domestically and internationally.

In one embodiment of the present invention, the system will provide the ability close the gap in ADS-B service to the surface for small airports and remote areas currently without ADS-B coverage.

In one embodiment of the present invention, the system will be many times less expensive than the current ADS-B GBTs deployed for the FM national ADS-B coverage and thus practical to deploy at small airports and other uncovered remote areas where full ADS-B coverage is important for air safety.

In one embodiment of the present invention the system will provide near real time traffic data for aircraft on the surface as well as aircraft taking off and landing from airports without ADS-B coverage.

In one embodiment of the present invention the system will provide ADS-B weather data to aircraft on the surface preparing to depart as well as aircraft taking off and landing.

Further understanding of the present invention will be had from the following description and claims taken in conjunction with the accompanying drawings.

### BRIEF DESCRIPTION OF THE DRAWINGS

FIG. 1 is a diagram showing a preferred embodiment of a system of the present invention; and

FIG. 2 is a block diagram illustrating a preferred embodiment of the method of the present invention: and

FIG. 3 is a block diagram illustrating the computer algorithm incorporated into to the system to receive ADS-B data from one or more ADS-B to the surfaces, consolidate the traffic data, and eliminate duplicates, format and send consolidated data to mGBT for transmission.

### SUMMARY OF THE INVENTION

An ADS-B to the surface system has a modified ADS-B UAT to the surface transceiver which receives traffic and weather information from a nearby FAA ADS-B Ground Based Transceiver. The UAT to the surface transceiver sends the information to a UAT computer which then packages and sends traffic and weather data over an appropriate network to one or more remote computers. The system also has a mini ADS-B Ground Based Transceiver which provides local traffic information to the remote computer which consolidates the information with the information from the UAT computer and then sends the consolidated information to the mini ADS-B Ground Based Transceiver which transmits the information to local aircraft on both 978 MHz and 1090 MHz. The remote computer may also send local only data to the FAA over an appropriate network for inclusion in the FAA Ground Based Transceiver information.

### DESCRIPTION OF THE INVENTION

Broadly speaking, the present invention is an ADS-B to the surface system comprising a modified ADS-B UAT to the surface, a computer, a remote computer, and a variable output power ADS-B transceiver. The ADS-B UAT to the surface transceiver is connected to the UAT Computer which is networked with the remote computer which is connected to the variable output power ADS-B transceiver.

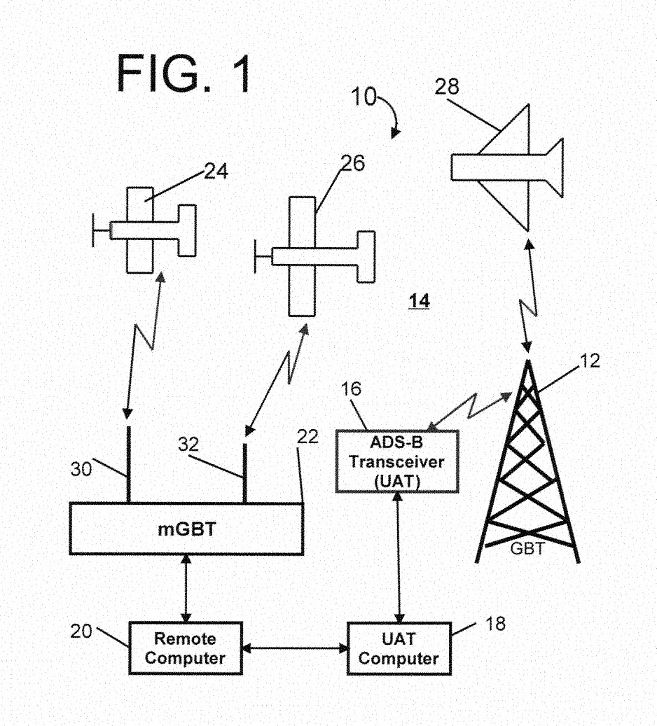

Now referring to FIG. 1, a preferred embodiment of the present invention is shown and indicated generally by the numeral 10. System 10 is intended to work with an FAA ADS-B ground based transceiver 12 to support ADS-B for the U.S. national airspace 14. Of course, it will be appreciated that the present invention can be used in airspace of other countries although such use may be limited to traffic information unless the country's ADS-B system uses 978 MHz. Thus, system 10 has a modified ADS-B UAT transceiver 16 which is in communication with UAT computer 18 which is networked with one or more remote computers 20 each of which is in communication with a mini-GBT (mGBT) ADS-B transceiver 22.

FAA ADS-B transceiver 12 is a conventional FAA ADS-B ground based ADS-B transceiver represented by antenna 12 in FIG. 1. These ground transceivers are in place around the United States to serve aircraft in United States airspace, but as pointed out above, the number of GBT's and their location leaves much airspace without service.

Modified ADS-B UAT transceiver 16 is a modified UAT-ADS-B transceiver which transmits to trigger traffic data from the FAA GBT 12 (when ADS-B traffic data is not being transmitted) and receives ADS-B Traffic and Weather data from the FAA GBT 12.

UAT computer 18 is connected to a modified UAT 16 to receive ADS-B data from FAA GBT 12, process the data and send to remote Computer(s) 20.

Remote computer 20 receives data from mGBT 22 and UAT Computer(s) 18 and performs various processing of the data. Remote computer 20 sends processed data back to mGBT 22 for transmission to low flying aircraft 24 with 978 MHz ADS-B In and low flying aircraft 26 with 1090 MHz ADS-B In. High flying aircraft 28 transmit and receive on 978 MHz ADS-B or 1090 MHz ADS-B directly to the FM GBT 12 but are out of range to receive from the low power mGBT.

Mini-GBT (mGBT) ADS-B transceiver 22 is preferably a variable output power to custom ADS-B GBT which receives local aircraft and UAV traffic and transmits consolidated data on 978 MHz and 1090 MHz for local traffic. Transceiver 22 has antenna 30 to receive local ADS-B Traffic data and transmit consolidated traffic data and weather data on 978 MHz. Transceiver 22 also has antenna 32 to receive local ADS-B data and transmit consolidated traffic data on 1090 MHz, and other possible IS frequencies.

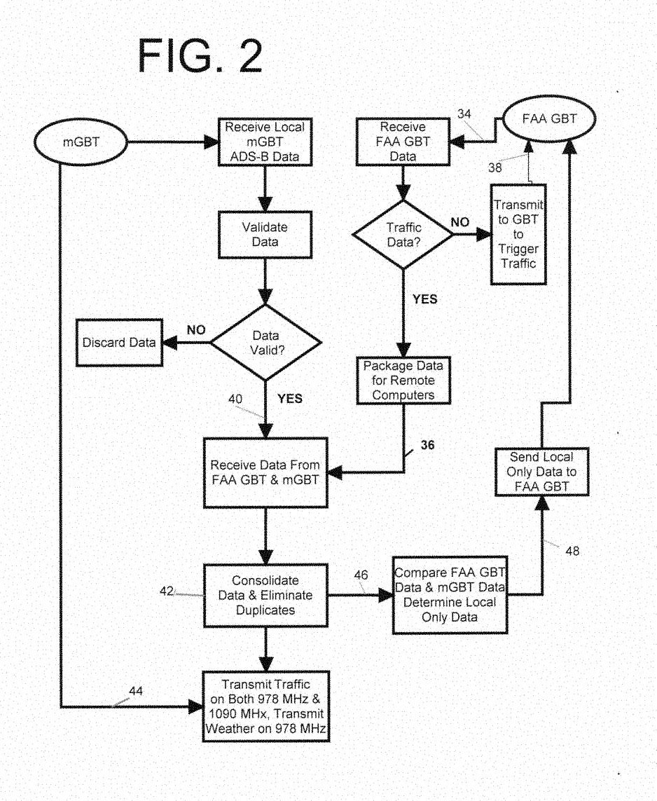

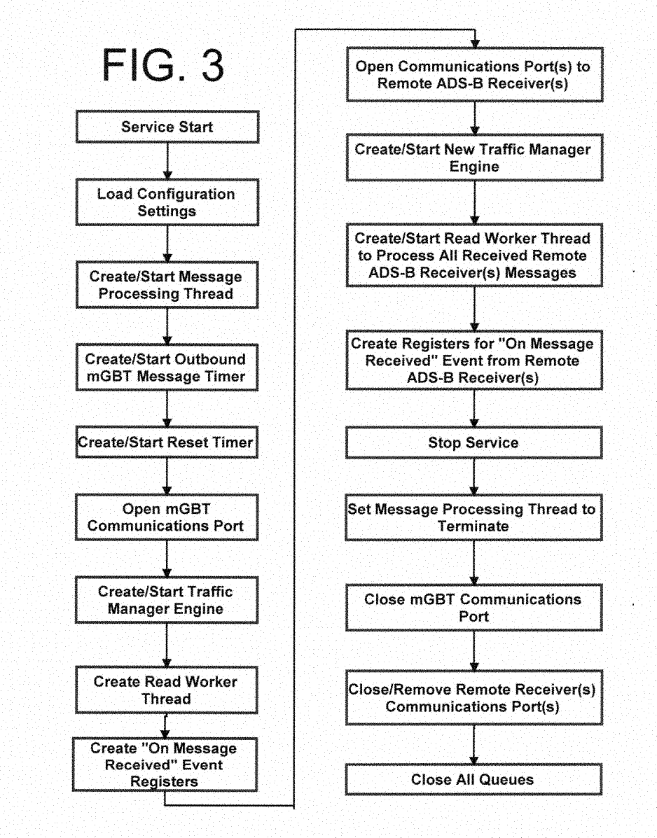

A method of operation of a preferred embodiment of the present invention is described by reference to FIGS. 1, 2 and 3. FIG. 1 illustrates the parts of a system for carrying out the method. FIG. 2 is a block diagram illustrating the method steps and FIG. 3 is a block diagram illustrating the computer algorithm incorporated into the system to receive ADS-B data from one or more ADS-B to the surfaces, consolidate the traffic data, and eliminate duplicates, format and send consolidated data to mGBT for transmission.

ADS-B UAT (978 MHz) transceiver 16 is proximately located within transmit and receive range of an FAA GBT 12 and receives ADS-B Traffic and Weather data transmitted by the FAA GBT 12 as indicated by arrow 34 in FIG. 2. UAT computer 18 which is connected to the ADS-B UAT 16 processes the ADS-B data and develops and sends the ADS-B messages via appropriate network connection to one or more remote computers 20 as indicated by arrow 36 in FIG. 2. If the FAA GBT data does not include traffic data, UAT computer 18 sends a message through ADS-B transceiver 16 to the FAA GBT 12 to trigger output of traffic data as indicated by arrow 38 in FIG. 2.

Each remote computer 20 receives the ADS-B messages from UAT computer 18 as indicated by arrow 36. Each remote computer 20 is located at an airport or remote area and is adapted to also receive local traffic ADS-B data from the mGBT 22 at the airport or remote area as indicated by arrow 40. Each mGBT 22 receives data on 978 MHz and 1090 MHz from local aircraft.

Remote Computers 20 compares messages in queue from UAT Computer 18 and mGBT 22 and consolidates the data as indicated by box 42. Remote Computer 20 eliminates duplicates and sends consolidated messages to mGBT 22 as indicated by arrow 44.

The mGBT 22 transmits the consolidated traffic data on 978 MHz (12) and 1090 MHz. to low flying aircraft 24 and 26 respectively.

As indicated by arrows 46 and 48 the Remote computers 20 compare messages from the UAT 16 and the mGBT 22 to identify local traffic data received by the mGBT 22 that was not received by the UAT 16, then the Remote computers 20 send local traffic data to the FAA via an appropriate network connection for consolidation into GBT 12 output via appropriate network connection.

It will be appreciated by those skilled in the art that the present invention is subject to modification and variation. It is intended that such modifications and variations are to be considered to be within the broad scope of the invention which is intended to be limited only by the following claims.

What is claimed is:

1. An ADS-B to the surface system to receive local traffic and FAA GBT Traffic and rebroadcast said local traffic and said FAA GBT traffic on both 978 MHz and 1090 MHz, said system comprising a modified ADS-B UAT to the surface connected to a UAT computer which is networked with at least one remote computer which is in communication with a mini ADS-B Ground Based Transceiver (mGBT).

2. The system of claim 1, wherein said ADS-B UAT to the surface is located within receive/transmit range of a FAA ADS-B Ground Based Transceiver (GBT).

3. The system of claim 1, wherein said remote computer connected to said mini ADS-B Ground Based Transceiver (mGBT) is networked with said FAA Ground Based Transceiver.

4. The method of rebroadcasting ADS-B local traffic and FAA GBT Traffic and weather, the method comprising
locating a UAT ADS-B to the surface within receiving range of an FAA Ground based Transceiver;
sending traffic and weather information received by said to the surface to a UAT computer;
packaging said weather and traffic information and sending said information to a remote computer which is in communication with a mini ADS-B Ground Based Transceiver (mGBT);
receiving local ADS-B traffic data using 978 MHz and 1090 MHz on said mini-ADS-B Ground Based Transceiver (mGBT) and providing said data to said remote computer; and
consolidating said data and eliminating duplicates and rebroadcasting the consolidated data at low power on ADS-B frequencies 978 MHz and 1090 MHz.

5. A method as in claim 4, including transmitting a message to the FAA Ground Based Transceiver when local ADS-B traffic is not being transmitted by the FAA GBT to trigger transmitting traffic data.

6. A method as in claim 4, wherein duplicate TIS and ADS-B traffic is eliminated by a computer system which receives, consolidates, and eliminates duplicate data.

7. A computer algorithm to run as a service to receive ADS-B data from one or more ADS-B to the surfaces, consolidate said data once per second, eliminate duplicate data, format and send reduced ADS-B data to a transmitter to transmit on 978 MHz and 1090 MHz.
